(19) United States
(12) Patent Application Publication
(10) Pub. No.: US 2019/0100404 A1
(43) Pub. Date: Apr. 4, 2019

(54) POWER ARRANGEMENT

(71) Applicant: KONE CORPORATION, Helsinki (FI)

(72) Inventors: Ari HÄNNINEN, Hyvinkää (FI); Tapio TYNI, Hyvinkää (FI)

(73) Assignee: KONE CORPORATION, Helsinki (FI)

(21) Appl. No.: 16/208,019

(22) Filed: Dec. 3, 2018

Related U.S. Application Data
(63) Continuation of application No. PCT/FI2016/050476, filed on Jun. 28, 2016.

(51) Int. Cl. B66B 1/30; H02J 7/00

(52) U.S. Cl. CPC B66B 1/302; H02J 7/0047; H02J 2007/0049; H02J 2007/005; B66B 2201/216

(57) ABSTRACT

Elevator groups are known have very high peak power demand. The peak power capacity of the power line can be reduced by using a power arrangement involving a battery. The battery can be discharged for operating elevators when the power demand exceeds the capacity of the power line. The battery may be further used for reducing power cost by charging the battery during lower cost time.

### DESCRIPTION OF BACKGROUND

The description relates to a power arrangement for buildings. Particularly the description relates to a power arrangement to be used in buildings having at least one elevator group.

Modern buildings are practically always equipped with elevators. When buildings are larger the elevators are typically larger and also the number of elevators increases. This means that the possible peak power level needed to operate elevators increases. Thus, buildings need to be equipped with a power connection that is able to operate elevators in all possible conditions smoothly and safely.

The need for power for one elevator is at largest when an elevator is accelerating into so called heavy direction. For example, when an elevator is full of people and it accelerates upwards the peak power for that particular elevator is needed. Similar situation occurs also when an empty elevator is accelerated downwards because at the same time the counterweight that is heavier than empty elevator car is accelerated upwards. The highest need for power occurs during the acceleration and after acceleration the need for power is reduced.

Modern buildings typically have more than one elevator. Larger buildings may even have a plurality of elevator groups that are used continuously. For example, during morning rush hour a lot of people are arriving at an office building through a lobby. It is possible that more than one elevator leaves at the same time into the heavy direction. Simultaneous accelerations are even probable because the elevators often have more than one acceleration and deceleration before the last passenger has exited the elevator car. Then the elevator car may be returned back to the lobby. When the accelerations are occurring at the same moment more than one elevator needs the maximum power. Thus, the building needs to be equipped with an adequate power supply according to the peak power that may be needed for operating a plurality of elevators demanding peak power simultaneously.

The above problem has been addressed by using scheduling systems that try to schedule movements of elevators in a manner that simultaneous accelerations into heavy direction are reduced. This can be achieved, for example, postponing the start of an elevator car by a short period. However, in some situations scheduling systems may cause unnecessary delays to passengers who will feel it inconvenient even if the delay is actually very short.

The power connection to a building needs to be such that it can provide power to all needs of the building continuously. As increasing peak power capacity is expensive and may require big and complex transforming stations there is always a need for reducing the peak power. Furthermore, the price of the power connection is often at least partially dependent on the required peak power level. Thus, there is a need for reducing required peak power while maintaining high service level.

### SUMMARY

Elevator groups are known have very high peak power demand. The peak power capacity of the power line can be reduced by using a power arrangement involving a battery. The battery can be discharged for operating elevators when the power demand exceeds the capacity of the power line. The battery may be further used for reducing power cost by charging the battery during lower cost time.

In an embodiment a method for controlling power supply of at least one elevator. In the method power is provided to at least one elevator from a power line. The power use of the at least one elevator is monitored according to predetermined conditions. When at least one predetermined condition is met the power from a power line is supplemented from at least one battery.

In an embodiment one predetermined condition is a predetermined power demand threshold level. This predetermined threshold level can be set so that it does not exceed the power line peak power dedicated to elevators. In another embodiment one predetermined condition is battery charging level. For example, when battery is still full in early evening and cheaper power tariff is expected to start the battery may be discharged and then recharged again when the power price is lower. In another embodiment the batter charging level is used so that the battery is not charged too full so that possibly regenerated power can be stored. In a further embodiment the regenerated power is used to charge the battery.

In a further embodiment a scheduling arrangement is used together with the battery. The scheduling arrangement schedules elevator journeys in a manner that the peak power demand is reduced.

In an embodiment the method disclosed above is implemented as a computer program. The computer program is configured to perform the method when executed in a computing device.

In an embodiment a building electricity control device is disclosed. The building electricity control device comprises at least one power line connection, at least one power connection configured to provide power for at least one elevator and at least one power connection configured to connect to at least one battery. The building electricity control device further comprises at least one processor configured to execute computer programs and at least one memory configured to store computers programs and related data. The building electricity control device is configured to perform a method as described above.

In a further embodiment an elevator arrangement is disclosed. The arrangement comprises at least one elevator, at least one battery and at least one building electricity control device.

The embodiments disclosed above have multiple benefits. One benefit is that when using a power arrangement with a battery it is possible to reduce the power line peak power capacity which will lead into cost savings and simplify the transformer stations needed for large buildings. This simplification will lead into further power savings. A further savings can be achieved when the power arrangement is combined with elevator scheduling arrangement that reduces further the required peak power. Compared to an arrangement with just scheduling arrangement the use of power arrangement as described will both reduce required peak power capacity and increase the level of service.

A further benefit of the embodiments disclosed above is that the battery can be charged when the lower power tariff is applied. Lower tariff is used typically during night time. Correspondingly, power from the battery can be discharged when higher power tariff is applied. This will reduce the cost of the power and also has a stabilizing effect to the whole electricity network as the peak power demand from the network is reduced and the overall consumption is distributed time-wise more evenly.

### BRIEF DESCRIPTION OF THE DRAWINGS

The accompanying drawings, which are included to provide a further understanding of the power arrangement and constitute a part of this specification, illustrate embodiments and together with the description help to explain the principles of the power arrangement. In the drawings:

FIG. 1 is a block diagram of the power arrangement,

FIG. 2 is a flow chart of a simple method used in a power arrangement,

FIG. 3 is a flow chart of a simple method used in a power arrangement.

### DETAILED DESCRIPTION

Reference will now be made in detail to the embodiments, examples of which are illustrated in the accompanying drawings.

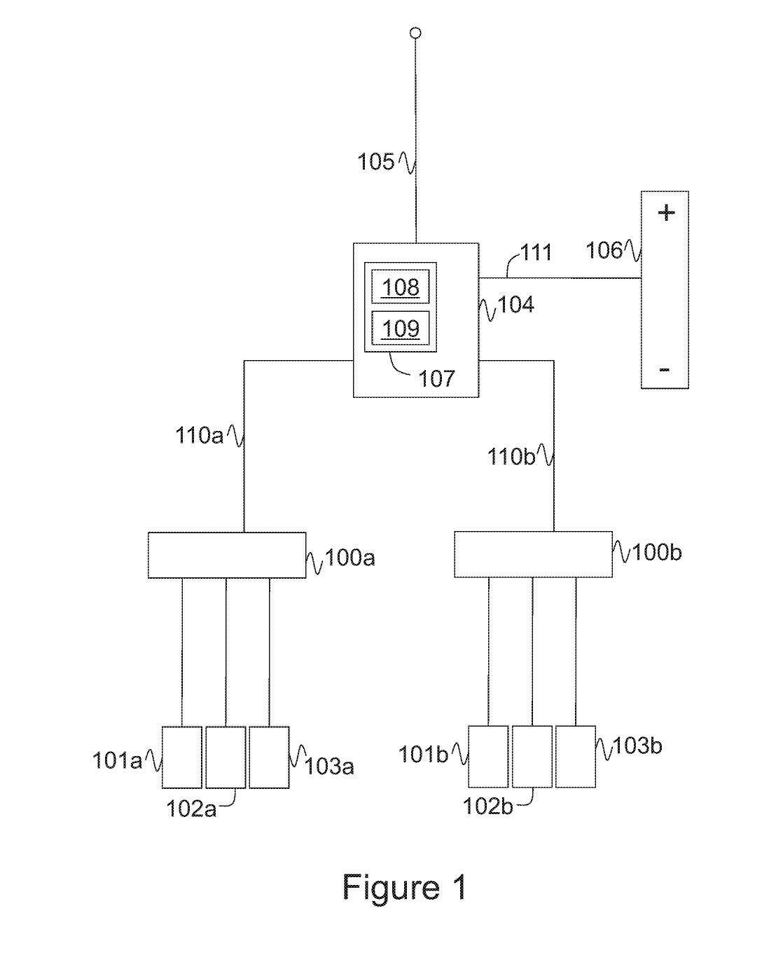

In FIG. 1 a power arrangement for elevators is disclosed. In the figure two elevator groups 100a-103a and 100b-103b are disclosed. The groups may be identical or of different configuration. For example, even if in the figure both groups have three elevators the number of elevators per group needs not to be the same.

The first elevator group is operated by hoisting arrangement 100a and the second elevator group is operated by hoisting arrangement 100b. Both arrangements include everything that is necessary to operate the elevator group. These arrangements are coupled to a power switching arrangement or building electricity control device 104.

The building electricity control device 104 is coupled to the power line 105 and to a battery 106. Power line 105 is typically connected to a building transformer or similar that is configured to power the elevators and the rest of the building. The power line 105 may be bi-directional. Thus, when the elevators are operated into light direction they typically regenerate power. The regenerated energy may be fed back to the power network or used for other needs in the building.

The battery 106 is a large capacity battery. Instead of feeding back to the power network the regenerated power can be used to charge the battery 106 unless the battery 106 is fully charged. If the battery 106 is fully charged the power may be fed back to the power network. However, controlling battery charging levels may provide an additional advantage as the network connection needs not to be bi-directional. This will simplify the connection to the power grid and there is no need for making arrangements and contracts for feeding the power back to the grid.

The battery 106 is used as a supplementary source of power when peak power is needed. Thus, the maximum capacity of power line 105 can be reduced. The power switching arrangement is configured to detect when the elevator groups connected to the power switching arrangement 104 are demanding more power than the power line 105 is able to provide. When the higher need of power is detected the power switching arrangement 104 supplements the power line 105 by discharging the battery 106. Thus, the battery 106 is used to support powering elevator groups in the building.

The battery 106 needs to be large enough in terms of capacity. Furthermore, the battery 106 needs to be able to release power fast enough so that the short but high peak power demand can be fulfilled. The size and other properties of the battery vary according to the application and chosen power line capacity 105. Furthermore, when a scheduling system is used to reduce the peak power further the overall configuration dictates the parameters of the battery 106. For example, if the scheduling system is allowed to reduce the peak power by reducing the service level a smaller capacity battery may be used.

In the embodiment of FIG. 1 only one battery 106 is disclosed. However, a person skilled in the art understands that also other arrangements may be used. The large battery 106 may be constructed from a plurality of smaller batteries. Furthermore, in a further embodiment two or more equally sized battery arrangements are used so that one battery arrangement can be used if the other breaks. In another embodiments battery arrangements may be charged one at time and while charging one battery the others are being discharged when needed for supporting the power line 105. In such configuration it is possible to change batteries individually when the capacity has reduced too much.

In the embodiment of FIG. 1 the switching between battery power and power line power is performed by building electricity control device 104 which comprises power connections to the power grid 105, to at least one elevator group 110a, 110b and to at least one battery 111. The building electricity control device 104 further comprises a controller 107 comprising at least one processor 108 for executing computer programs that are configured to make the decision of the used power sources and at least one memory 109 for storing computer programs and related data.

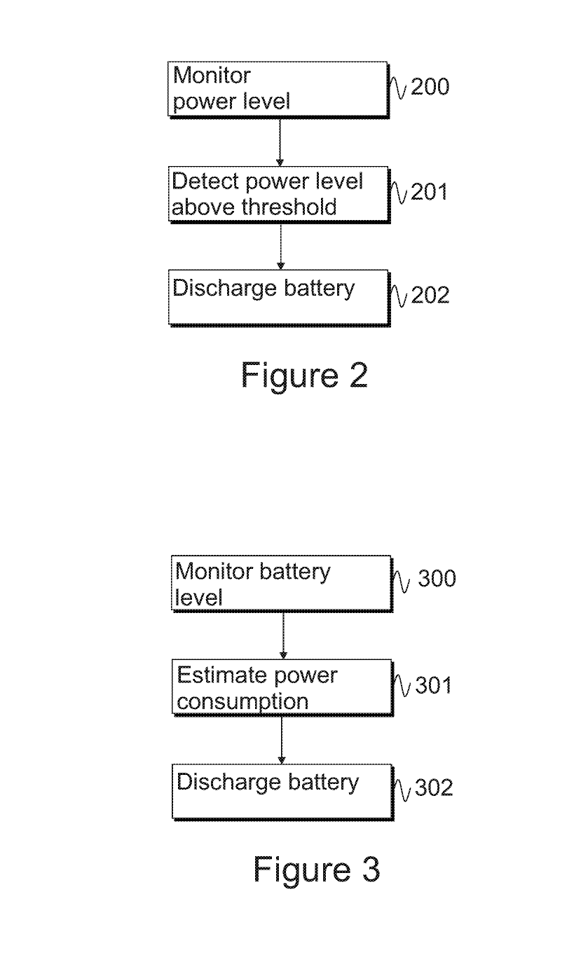

In FIG. 2 a simple method suitable to be used with a power arrangement similar to the power arrangement of FIG. 1 is disclosed.

The method is performed continuously as a process. The elevators or elevator groups connected to a power switching arrangement use power according to their current need. In the method of FIG. 2 the use of power is monitored continuously, step 200.

The monitored power level is continuously compared to a threshold value, step 201. The threshold value is determined based on application basis. For example, the threshold may be a static value that is based on the power value that cannot be exceeded with the current power connection. Instead of static threshold the threshold value may also be dynamically adjustable. For example, on a hot day more power is needed for air conditioning and the power used for air conditioning cannot be used for operating elevators. Thus, the threshold value may be changed to be lower. Correspondingly, if air conditioning is not needed the threshold may be increased.

If the demand for power exceeds the threshold value the battery is discharged, step 202. This will provide supplementary power for operating elevators. Thus, a situation where the demand exceeds the capacity of the power line can be handled without reducing service level.

In a further embodiment a scheduling software is used and a second threshold level is determined. The second threshold level is set to correspond the peak power of power line when supplemented with the battery. This value typically cannot be exceeded. Thus, the scheduling software needs to compute estimates of peak power and if it detects a situation where the second threshold level is exceeded it will reschedule journeys so that the second threshold is not exceeded.

FIG. 3 discloses another simple method suitable to be used with a power arrangement similar to the power arrangement of FIG. 1. The method of FIG. 3 may be used simultaneously with the method of FIG. 2.

The method is initiated by monitoring battery level continuously, step 300. The monitoring includes at least monitoring the charging level of the battery. For example, it is possible to set limit between which the charging level is maintained. If the charging level is too low the battery needs to be charged so that when peak power is needed it can be provided. Correspondingly, when the charging level is too high the battery can be discharged so that if elevators regenerate power it can be stored into the battery. Discharging of battery can naturally be used for elevator operation. Thus, during discharging the power needed from the power connection is reduced.

In the method of FIG. 3 it is assumed that the building has different day and night tariffs for power. In the method the power consumption is estimated, step 301. When it is detected that the power level is high enough to support the rest of the day the battery may be discharged, step 302. Then, when the cheaper tariff rate is available the batteries may be fully charged. Thus, next morning when the tariff changes back to the expensive day tariff the batteries are fully charged and the need of more expensive power is reduced.

The above mentioned method may be implemented as computer software which is executed in a computing device. When the software is executed in a computing device it is configured to perform the above described inventive method. The software is embodied on a computer readable medium so that it can be provided to the computing device, such as the device 107 of FIG. 1.

As stated above, the components of the exemplary embodiments can include computer readable medium or memories for holding instructions programmed according to the teachings of the present embodiments and for holding data structures, tables, records, and/or other data described herein. Computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the power arrangement may be implemented in various ways. The power arrangement and its embodiments are thus not limited to the examples described above; instead they may vary within the scope of the claims.

1. A method for controlling power supply of at least one elevator comprising:
providing power to at least one elevator from a power line;
monitoring power use of said at least one elevator according to predetermined conditions, wherein the monitoring further comprises:
determining a first threshold value on application basis;
determining a second threshold value and setting the second threshold value to correspond to the peak power of power line when supplemented with at least one battery;
supplementing said power from a power line from at least one battery when the first threshold value is met; and
computing estimates of peak power and when detecting a situation where the second threshold level is exceeded the method further comprises rescheduling journeys so that the second threshold is not exceeded.

2. The method according to claim 1, wherein one predetermined condition is a predetermined power demand threshold level.

3. The method according to claim 1, wherein one predetermined condition is battery charging level.

4. The method according to claim 1, wherein one predetermined condition is an estimate of power cost and said condition is used in order to reduce the cost.

5. The method according to claim 1, wherein charging said at least one battery when said at least one elevator is regenerating power.

6. A computer program embodied on a non-transitory computer readable medium, wherein said computer program is configured to perform the steps of claim 1 when executed in a computing device.

7. A building electricity control device, comprising:
at least one power line connection;
at least one power connection configured to provide power for at least one elevator;
at least one power connection configured to connect to at least one battery;
at least one processor configured to execute computer programs; and
at least one memory configured to store computers programs and related data,
wherein said building electricity control device is configured to perform the method according to claim 1.

8. An elevator arrangement comprising:
at least one elevator;
at least one battery; and
at least one building electricity control device according to claim 7.

9. The method according to claim 2, wherein one predetermined condition is battery charging level.

10. The method according to claim 2, wherein one predetermined condition is an estimate of power cost and said condition is used in order to reduce the cost.

11. The method according to claim 3, wherein one predetermined condition is an estimate of power cost and said condition is used in order to reduce the cost.

12. The method according to claim 2, wherein charging said at least one battery when said at least one elevator is regenerating power.

13. The method according to claim 3, wherein charging said at least one battery when said at least one elevator is regenerating power.

14. The method according to claim 4, wherein charging said at least one battery when said at least one elevator is regenerating power.

15. A computer program embodied on a non-transitory computer readable medium, wherein said computer program is configured to perform the steps of claim 2 when executed in a computing device.

16. A computer program embodied on a non-transitory computer readable medium, wherein said computer program is configured to perform the steps of claim 3 when executed in a computing device.

17. A computer program embodied on a non-transitory computer readable medium, wherein said computer program is configured to perform the steps of claim 4 when executed in a computing device.

18. A computer program embodied on a non-transitory computer readable medium, wherein said computer program is configured to perform the steps of claim 5 when executed in a computing device.

19. A building electricity control device, comprising:
at least one power line connection;
at least one power connection configured to provide power for at least one elevator;
at least one power connection configured to connect to at least one battery;
at least one processor configured to execute computer programs; and
at least one memory configured to store computers programs and related data,
wherein said building electricity control device is configured to perform the method according to claim 2.

20. A building electricity control device, comprising:
at least one power line connection;
at least one power connection configured to provide power for at least one elevator;
at least one power connection configured to connect to at least one battery;
at least one processor configured to execute computer programs; and
at least one memory configured to store computers programs and related data,
wherein said building electricity control device is configured to perform the method according to claim 3.
